(19) United States
(12) Patent Application Publication
(10) Pub. No.: US 2009/0287551 A1
(43) Pub. Date: Nov. 19, 2009

(54) Multi-level real estate method and system

(76) Inventor: Lawrence Richard Smith, Cape Coral, FL (US)

Correspondence Address: George F. Wallace, 2010 Willow Branch Drive, Cape Coral, FL, 33991, US

(21) Appl. No.: 12/460,709

(22) Filed: Jul. 23, 2009

Related U.S. Application Data
(63) Continuation of application No. 12/380,673, filed on Mar. 2, 2009.
(60) Provisional application No. 61/067,412, filed on Feb. 28, 2008.

(51) Int. Cl. G06Q 10/00; G06Q 50/00; G06Q 20/00; G06Q 40/00

(52) U.S. Cl. 705/11; 705/39

(57) ABSTRACT

A method of compensating a plurality of participants, includes hierarchically representing, in a database communicatively associated with a computer, a multi-level real estate team, the team being based upon sponsoring of members in the team; collecting a membership fee from each member of the team, the membership fee being independent of a real estate transaction; placing the collected fees into a revenue pool; determining by the computer, via interrogation against the database, a respective team bonus for respective team members based at least in part on the hierarchy between the team members; and distributing, based at least in part on the computer determination, the respective team bonuses from the revenue pool to respective team members.

### RELATED AND PRIORITY DOCUMENTS

This disclosure is related to, incorporates by reference in its entirety, and claims the priority benefit of U.S. patent application Ser. No. 12/380,673 entitled “MULTI-LEVEL REAL ESTATE METHOD AND SYSTEM” filed by SMITH on Mar. 2, 2009, which is related to, incorporated by reference in its entirety, and claimed the priority benefit of U.S. Provisional Patent Application Ser. No. 61/067,412 entitled “MULTI-LEVEL REAL ESTATE SYSTEM AND METHOD” filed by SMITH on Feb. 28, 2008.

### FIELD OF THE INVENTION

The present invention relates to real estate methods and system, and more specifically, to multi-level real estate methods and systems.

### BACKGROUND OF THE INVENTION

Real estate methods and systems are geared towards facilitating actions involved in real estate enterprises, which can include sales, leases, etc. of real estate. Multi-level systems and methods are geared towards incentivizing those involved in real estate enterprises.

### BRIEF SUMMARY OF THE INVENTION

It is, therefore, an object of the present invention to provide a multi-level real estate method and system.

In an exemplary embodiment of the present invention, a method of compensating a plurality of participants, can include the following steps: hierarchically representing, in a database communicatively associated with a computer, a multi-level real estate team, the team being based upon sponsoring of members in the team; collecting a membership fee from each member of the team, the membership fee being independent of a real estate transaction; placing the collected fees into a revenue pool; determining by the computer, via interrogation against the database, a respective team bonus for respective team members based at least in part on the hierarchy between the team members; and distributing, based at least in part on the computer determination, the respective team bonuses from the revenue pool to respective team members.

According to an exemplary aspect of the present invention, the step of determining can include determining the respective team bonus for respective team members based upon: (i) a first level portion of the revenue pool, and (ii) a second level portion of the revenue pool.

According to an additional exemplary aspect of the present invention, at least one member can be at least one of a seller agent, a listing agent, a buyer agent, a real estate broker, a title agent, and a lending agent.

According to still another exemplary aspect of the present invention, the team can include at least one member having sponsored at least two subsequent levels of members into the team.

According to yet another exemplary aspect of the present invention, a bonused member receives a team bonus if the bonused member sponsored another member that was productive, or real estate-based productive.

In another exemplary embodiment of the present invention, a computer system for effectuating a team bonus distribution for a multi-level real estate team can include the following: a database, communicatively associated with a computer, for hierarchically representing the multi-level real estate team, the team being based upon sponsoring of members in the team; and a determination module for determining via computer interrogation against the database a respective team bonus for respective team members based at least in part on the hierarchy of the team members; wherein the respective team bonuses are funded from a revenue pool funded from membership fees collected from each member of the team.

According to an exemplary aspect of the present invention, the determination module can determine the respective team bonus for respective team members based upon: (i) a first level portion of the revenue pool, and (ii) a second level portion of the revenue pool.

According to another exemplary aspect of the present invention, at least one team member can be at least one of a seller agent, a listing agent, a buyer agent, a real estate broker, a title agent, and a lending agent.

According to an exemplary aspect of the present invention, the team can include at least one member having sponsored at least one subsequent level of members into the team.

According to an exemplary aspect of the present invention, a bonused member receives a team bonus if the bonused member sponsored at least one other member that was productive, or real estate-based productive.

In another exemplary embodiment of the present invention, a method of compensating a plurality of team members within a multi-level real estate team includes the following steps: forming the multi-level real estate team based upon sponsoring of members into the team, the team having at least one of the members having sponsored at least two subsequent levels of members into the team; hierarchically representing the multi-level real estate team in a computer database communicatively associated with a computer; collecting a membership fee from each member in the team, the fee being independent of a real estate transaction; placing the collected fees into a revenue pool; determining by the computer, via interrogation against the database, a team bonus distribution based at least in part on (i) a first level portion of the revenue pool, and (ii) a second level portion of the revenue pool; and distributing, from the revenue pool, the team bonuses based at least in part on the team bonus distribution; wherein for each team member that is real estate-based productive during a performance period, at least one respective team bonus is distributed to each team member up-line to the productive team member.

In another exemplary aspect of the present invention, the respective team bonuses can be distributed electronically.

### BRIEF DESCRIPTION OF DRAWINGS

The present invention is illustrated by way of example, and not in limitation, in the figures of the accompanying drawings, in which:

FIG. 1 illustrates an exemplary multi-level real estate team according to the present invention.

FIG. 2 illustrates an exemplary multi-level real estate team according to the present invention, in which team members are associated with levels.

FIG. 3 illustrates an exemplary team bonus schedule based on team member levels.

FIG. 4 illustrates a multi-level real estate team according to the present invention, in which distinctions are made between team members who were productive and unproductive.

### DETAILED DESCRIPTION

The invention will now be described in more detail by way of example with reference to the embodiments shown in the accompanying figures. It should be kept in mind that the following described embodiments are only presented by way of example and should not be construed as limiting the inventive concept to any particular physical configuration or order.

Multi-Level Real Estate Team

According to the present invention, a multi-level real estate team (“team”) is defined as a plurality of team members. Aside from an initial member, who initiates a team, a team member joins the team via sponsorship or recruitment by another team member.

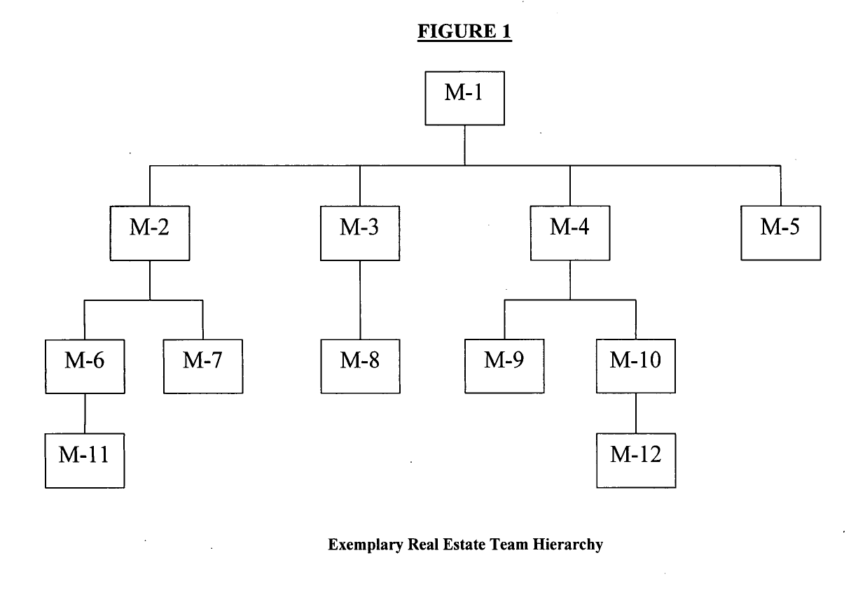

Reference is now made to FIG. 1, which illustrates an exemplary real estate team hierarchy according to the present invention. As illustrated, initial member M-1 is positioned at the top of the hierarchy, as this member initiated the team. As can be further illustrated in this hierarchy, team members M-2, M-3, M-4, and M-5 were sponsored or recruited into the team by initial member M-1. Likewise, team members M-6, M-7, and M-11 were sponsored by team member M-2. Accordingly, this illustrative hierarchy depicts the relationship of sponsorship or recruitment that formed this team.

According to another exemplary aspect of the present invention, a team can be optionally defined as having at least one member who has sponsored at least two subsequent levels of members into the team. Thus, via this limitation, a team must “build” via sponsorship or recruitment such that it achieves this, or any other desired, state before the team can qualify for team bonuses. Additionally, via this limitation, the recognition of sub-teams can be allowed such that single team members can receive an additional team bonus based on their inclusion within a sub-team (additionally described below). This form of incentive can assist in the building of teams such that they reach sufficient size to realize positive team bonus incentives, as well as other potential benefits. Notably, various other limitations can be imposed alternatively or conjunctively to further incentivize team members. For example and not in limitation, a team can be defined as having at least one member who has sponsored at least one subsequent level of members. The exact definition of any such aspect will be a design choice.

According to the present invention, a real estate enterprise encompasses myriad aspects, and therefore can include myriad types of individuals and/or entities; and further, engaging in real estate business includes a broad range of activities, such as the sale, lease, and/or option of real property, and even aspects involved in financial aspects of real estate. Therefore, a team member can be drawn from any aspect involved with a real estate enterprise. Thus, for example and not in limitation, a team member can include at least one of a seller agent, a listing agent, a buyer agent, a real estate broker, a title agent, and a lending agent. Further, it should be noted that the term “agent” throughout this disclosure is hereby expressly intended to additionally include fictitious entities, such as, for example and not in limitation, corporations, companies, partnerships, etc.

According to the present invention, a team can be represented in any type of computer database such that preservation of the hierarchical relationship between the team members is achieved. Also according to the present invention, a computer database is communicatively associated with a computer such that processing of, or interrogation against, the data contained therein can occur.

Also according to the present invention, a team can be construed as a macro-team that includes sub-teams. Thus, for example, referring to FIG. 1, one sub-team can be defined as team members M-1 through M-12, a second sub-team can be defined as team members M-2, M-6, M-7, and M-11, and a third sub-team can defined as team members M-4, M-9, M-10, and M-12. Notably, sub-teams can be defined as requiring a particular number of members and/or a particular number of sponsorship requirements, such that one or more particular goal or logical states, including the establishment of particular incentive benefits, are established.

Membership Fee

According to the present invention, a membership fee is collected from each member of the team. Naturally, a membership fee can be fixed or variable. After collection, membership fees can be placed into a revenue pool.

According to an exemplary aspect of the present invention, membership fees can be collected in a recurring manner and/or based on one or more time periods and/or events. For example and not in limitation, membership fees can include one or more of a periodic membership fee, an event-based membership fee, and an initiation fee, etc. Notably, the manner of fee collection can depend on the timing in which team bonuses are distributed. In an exemplary aspect, a membership fee can optionally be independent of a real estate transaction, such that it is not based on a real estate transaction.

Determining Team Bonuses

According to an exemplary aspect of the present invention, team bonuses can be distributed in a recurring manner and/or based on particular events. For example, and not in limitation, team bonuses can be distributed on an annual basis. Also according to an exemplary aspect of the present invention, team bonuses are determined based on the hierarchy between the members of a team.

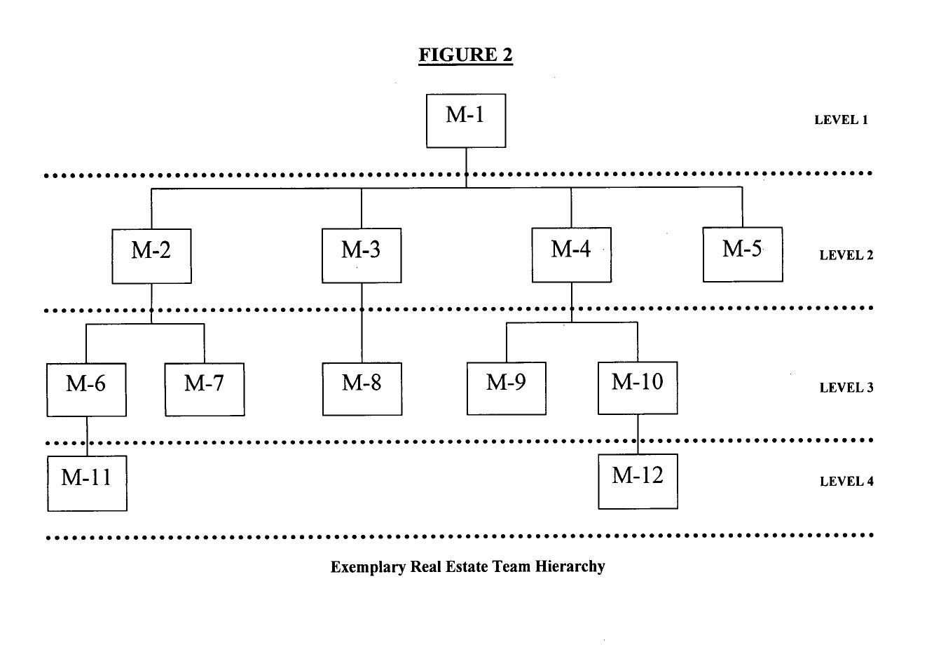

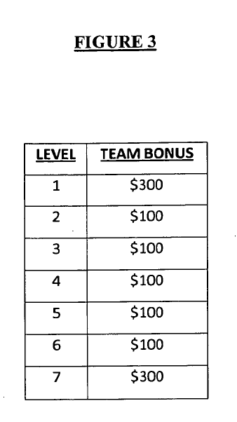

Reference is now made to FIGS. 2 and 3. As illustrated in FIG. 2, a team can include designated levels of team members based on the team member hierarchy, such as Levels 1-4, for example and not in limitation. As illustrated in FIG. 3, an exemplary bonus schedule can include particular bonus amounts that correspond to team hierarchy levels, such as illustrated levels 1 through 7, for example and not in limitation.

Top-Down Team Bonus Distribution

For illustrative purposes, the following is an exemplary bonus distribution based on the illustrations provided:

Referring to FIG. 2, the illustrated team includes team members M-1 through M-12, with team member M-1 being at Level 1, team members M-2 through M-5 being at Level 2, team members M-6 though M-10 being at Level 3, and team members M-11 and M-12 being at Level 4. Thus, as per FIG. 3, team member M-1 would receive a team bonus of $300 for being at Level 1; team members M-2 through M-5 would receive a team bonus of $100 for being at Level 2; team members M-6 through M-10 would receive a team bonus of $100 for being at Level 3; and team members M-11 and M-12 would receive $100 for being at Level 4.

However, as alluded to above, where sub-teams are recognized, additional team bonus distributions can exist. Referring to FIG. 2, a team can be defined, for example and not in limitation, as having at least one member who has sponsored at least two subsequent levels of members into the team. Therefore, in addition to the team emanating from team member M-1 (the macro-team), two additional teams exist within this hierarchy: micro-team one includes team members M-2, M-6, M-7, and M-11; and micro-team two includes M-4, M-9, M-10, and M-12.

Micro-team one qualifies as a team as team member M-2 has sponsored at least two additional levels of members: the first level includes team members M-6 and M-7, and the second level includes team member M-11. Micro-team two qualifies as a team as team member M-4 has sponsored at least two additional levels of members: the first level includes team members M-9 and M-10, and the second level includes team member M-12. It should be noted that a team could have been defined as having at least one member who has sponsored at least one additional level of members, in which case there would be additional micro- or sub-teams in the illustrative team.

Regarding the determination of team bonuses for these micro-teams, the level of sponsorship can change, for example and not in limitation. Illustratively, the initially sponsoring team members (here, team members M-2 and M-4) could be considered to be at Level 1. Therefore, as per the exemplary bonus schedule of FIG. 3, team members M-2 and M-4 could each receive a team bonus of $300 for being at Level 1 of their respective sub-teams. Accordingly, team members M-6, M-7, M-9, and M-10 would correspondingly receive respective team bonuses of $100 for being at Level 2 of their respective sub-teams; and team members M-11 and M-12 would receive team bonuses of $100 for being at Level 3 of their respective sub-teams.

As can be seen, the recognition of sub-teams can provide an extraordinarily heightened incentive for a team member to recruit team members who themselves possess recruiting skills, such that a sub-team can be formed and an additional team bonus can be realized.

Bottom-Up Team Bonus Distribution

For illustrative purposes, the following is another exemplary bonus distribution based on the illustrations provided:

Referring to FIG. 2, the illustrated exemplary team includes team members M-1 through M-12, with team member M-1 being at Level 1, team members M-2 through M-5 being at Level 2, team members M-6 though M-10 being at Level 3, and team members M-11 and M-12 being at Level 4. However, the illustrative bonus schedule of FIG. 3 can be applied in a bottom-up manner. Accordingly, for each particular team member, a team bonus can be provided in a level-by-level manner starting from the team member who recruited the particular team member, and continuing upwards until either a maximum level is reached (here, illustratively a seventh level) or a terminal team member is reached (here, illustratively team member M-1). Thus, for team member M-11, team member M-6 would receive a team bonus of $300 for being at Level 1, team member M-2 would receive a team bonus of $100 for being at Level 2, and team member M-1 would receive a team bonus of $100 for being at Level 3. This team bonus distribution can be repeated for each team member of the team. As can be seen, team members M-11 and M-12 would not receive a team bonus under this distribution, as they have not sponsored or recruited any team members. Notably, with the recognition of sub-teams, this bottom-up team bonus distribution can provide multiple team bonuses to single team members.

Regarding the determination of team bonuses for these micro-teams, the level of sponsorship can change, for example and not in limitation. Illustratively, the initially sponsoring team members (here, team members M-2 and M-4) would be considered to be at level 1. Therefore, as per the exemplary bonus schedule of FIG. 3, team members M-2 and M-4 would each receive a team bonus of $300 for being at level 1 of their respective sub-teams. Accordingly, team members M-6, M-7, M-9, and M-10 would correspondingly receive respective team bonuses of $100 for being at level 2 of their respective sub-teams; and team members M-11 and M-12 would receive team bonuses of $100 for being at level 3 of their respective sub-teams.

Optional Team Bonus Requirements

According to yet another exemplary aspect of the present invention, particular requirements can be imposed upon recruited team members in order for those who recruited them (either directly or indirectly) to receive a team bonus and/or for that team member to receive a team bonus. For example, and not in limitation, one such requirement can be that a recruited team member must be productive (in some measurable way, whether subjectively or objectively). For example and not in limitation, productivity can be satisfied if a team member is real estate-based productive, such as for example and not in limitation, performing some act that contributes to a real estate transaction or somehow contributes to that team member's role within in a real estate field.

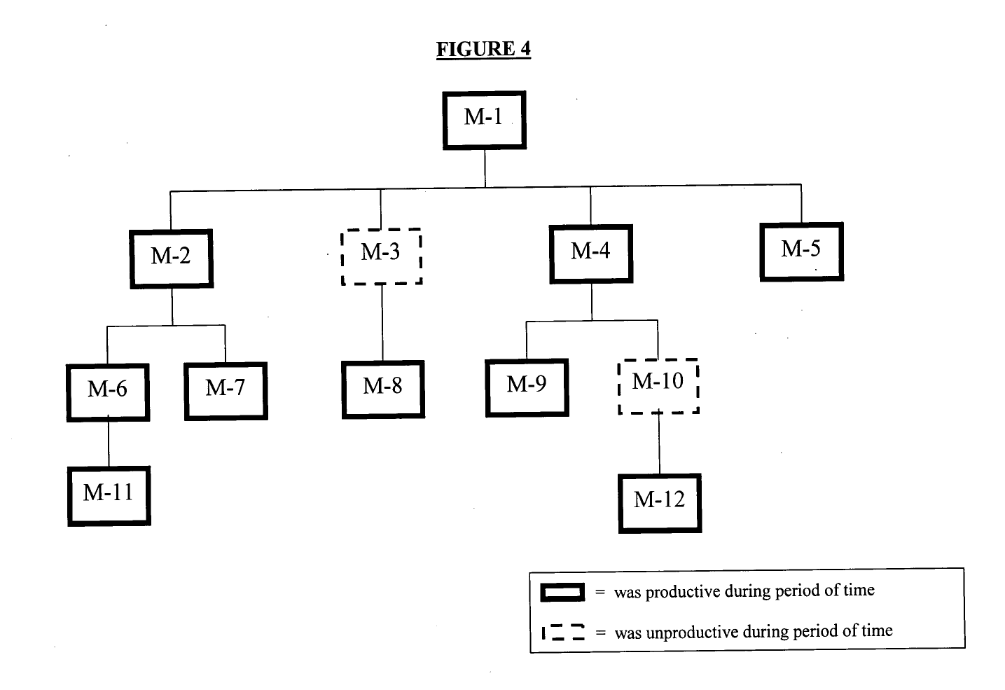

Referring to FIG. 4, illustratively, the team members M-3 and M-10 could be determined as having been unproductive during some period of time for team bonus determination purposes. Thus, in an exemplary top-down team bonus distribution, team members M-3 and M-10 may not receive a team bonus. Alternatively, in a bottom-up team bonus distribution, a team bonus may not spawn from team members M-3 and M-10; additionally or alternatively, in a bottom-up distribution, team-bonuses that respectively flow from below team members M-3 and M-10 may be respectively voided or skipped for team members M-3 and M-10.

In yet another exemplary aspect of the invention, distribution of team bonuses can be effectuated in any manner consistent with the spirit of the present invention, such as by check, cash, wire transfer, etc. For example, and not in limitation, distribution may be effectuated, in whole or in part, electronically.

It will be apparent to one skilled in the art that the manner of making and using the claimed invention has been adequately disclosed in the above-written description of the exemplary embodiments and aspects taken together with the drawings.

It should be understood, however, that the invention is not necessarily limited to the specific embodiments, aspects, arrangement, and components shown and described above, but may be susceptible to numerous variations within the scope of the invention. Accordingly, the specification and drawings are to be regarded in an illustrative and enabling, rather than a restrictive, sense.

Therefore, it will be understood that the above description of the embodiments of the present invention are susceptible to various modifications, changes, and adaptations, and the same are intended to be comprehended within the meaning and range of equivalents of the appended claims.

Therefore, I claim:

1. A method of compensating a plurality of participants, comprising the steps of:
hierarchically representing, in a database communicatively associated with a computer, a multi-level real estate team, the team being based upon sponsoring of members in the team;
collecting a membership fee from each member of the team, the membership fee being independent of a real estate transaction;
placing the collected fees into a revenue pool;
determining by the computer, via interrogation against the database, a respective team bonus for respective team members based at least in part on the hierarchy between the team members; and
distributing, based at least in part on the computer determination, the respective team bonuses from the revenue pool to respective team members.

2. The method of claim 1, wherein said step of determining includes determining the respective team bonus for respective team members based upon: (i) a first level portion of the revenue pool, and (ii) a second level portion of the revenue pool.

3. The method of claim 1, wherein at least one member is at least one of a seller agent, a listing agent, a buyer agent, a real estate broker, a title agent, and a lending agent.

4. The method of claim 1, wherein the team includes at least one member having sponsored at least one subsequent level of members into the team.

5. The method of claim 1, wherein a bonused member receives a team bonus if the bonused member sponsored another member that was productive.

6. The method of claim 1, wherein a bonused member receives a team bonus if the bonused member sponsored another member that was real estate-based productive.

7. A computer system for effectuating a team bonus distribution for a multi-level real estate team, comprising:
a database, communicatively associated with a computer, for hierarchically representing the multi-level real estate team, the team being based upon sponsoring of members in the team; and
a determination module for determining via computer interrogation against the database a respective team bonus for respective team members based at least in part on the hierarchy of the team members;
wherein the respective team bonuses are funded from a revenue pool funded from membership fees collected from each member of the team, the membership fees being independent of a real estate transaction.

8. The system of claim 7, wherein said determination module determines the respective team bonus for respective team members based upon: (i) a first level portion of the revenue pool, and (ii) a second level portion of the revenue pool.

9. The system of claim 7, wherein at least one team member is at least one of a seller agent, a listing agent, a buyer agent, a real estate broker, a title agent, and a lending agent.

10. The system of claim 7, wherein the team includes at least one member having sponsored at least one subsequent level of members into the team.

11. The system of claim 7, wherein a bonused member receives a team bonus if the bonused member sponsored at least one other member that was productive.

12. The system of claim 7, wherein a bonused member receives a team bonus if the bonused member sponsored at least one other member that real estate-based productive.

13. A method of compensating a plurality of team members within a multi-level real estate team, comprising the steps of:
forming the multi-level real estate team based upon sponsoring of members into the team, the team having at least some of the members having sponsored at least two subsequent levels of members into the team;
hierarchically representing the multi-level real estate team in a computer database communicatively associated with a computer;
collecting a membership fee from each member in the team, the membership fee being independent of a real estate transaction;
placing the collected fees into a revenue pool;
determining by the computer, via interrogation against the database, a team bonus distribution based at least in part on (i) a first level portion of the revenue pool, and (ii) a second level portion of the revenue pool; and
distributing, from the revenue pool, the team bonuses based at least in part on the team bonus distribution;
wherein for each team member that is real estate-based productive during a performance period, at least one respective team bonus is distributed to each team member up-line to the productive team member.

14. The method of claim 13, wherein the respective team bonuses are distributed electronically.
